(19) United States
(12) Patent Application Publication
(10) Pub. No.: US 2006/0121955 A1
(43) Pub. Date: Jun. 8, 2006

(54) Wireless telephone having adaptable power consumption

(75) Inventor: Eyal Shlomot, Long Beach, CA (US)

Correspondence Address: FARJAMI & FARJAMI LLP, Suite 360, 26522 La Alameda Avenue, Mission Viejo, CA, 92691, US

(73) Assignee: Mindspeed Technologies, Inc.

(21) Appl. No.: 11/007,616

(22) Filed: Dec. 7, 2004

(51) Int. Cl. H04B 1/38; H04M 1/00

(52) U.S. Cl. 455/574

(57) ABSTRACT

There is provided a method of adjusting power consumption by a wireless device having a codec and a battery, where the codec has a plurality of states of operation and the battery has a plurality of power levels. The method comprises operating the wireless device at a first power level of the plurality of power levels and a first state of the plurality of states of operation, while in communication with a remote device; receiving a power level indication indicative of a second power level of the plurality of power levels; selecting a second state of the plurality of states of operation for the codec corresponding to the second power level of the plurality of power levels; and modifying the codec to operate at the second state of the plurality of states of operation.

### BACKGROUND OF THE INVENTION

1. Field of the Invention

The present invention generally relates to wireless telephones and, more particularly, to extending the battery life for wireless telephones by adapting power consumption.

2. Background Art

An essential aspect of mobile communications is the generation and consumption of power. Power is one of the most precious commodities for wireless communications. Today, many are in pursuit of ways to provide longer lasting batteries, and to design devices that use less power allowing for wireless phones to operate with less frequent needs for a battery recharge.

Various techniques, both hardware and software, have been proposed to reduce the power consumption for wireless phones. For example, some software-level techniques have concentrated on non-communication components of the wireless phone, such as the display and the CPU. More specifically, the display may be turned off after some period of inactivity or the CPU may be slowed down or stopped depending on its workload. Hardware-level solutions for managing the wireless phone focus on modulating the power used by the wireless phone transmitter during active communication.

In view of the recent increase in the demand for wireless phones, many have first-hand experience with untimely depletion of wireless phone batteries. Quite often, users must either shorten wireless phone communications and rapidly end the communication due to the wireless phone battery being low, or the wireless phone communication is abruptly terminated and lost due to the wireless phone battery being completely depleted. In many instances, wireless phone users would appreciate having the ability to extend the communications period in exchange for reduced feature sets. For example, during an emergency call, such as a 911 call, wireless phone users would indeed prefer to disable any nonessential power-consuming feature of the wireless phone in order to extend the communications period.

Accordingly, there is still an intense need in the art for methods and systems to adapt power consumption to extend the battery life such that wireless telephone communications can continue for a longer period of time.

### SUMMARY OF THE INVENTION

The present invention is directed to extending the battery life of wireless telephones by adapting power consumption. In one aspect of the present invention, there is provided a method of adjusting power consumption by a wireless device having a codec and a battery, where the codec has a plurality of states of operation and the battery has a plurality of power levels. The method comprises operating the wireless device at a first power level of the plurality of power levels and a first state of the plurality of states of operation, while in communication with a remote device; receiving a power level indication indicative of a second power level of the plurality of power levels; selecting a second state of the plurality of states of operation for the codec corresponding to the second power level of the plurality of power levels; and modifying the codec to operate at the second state of the plurality of states of operation. The wireless device can be a wireless telephone and the codec can be a voice codec. In other aspects, the codec can be a video codec.

In one aspect, the second power level is lower than the first power level, and the second state consumes less power than the first state. In a further aspect, the codec operates at a lower average bit rate in the second state than in the first state. Yet, in other aspects, the codec has a plurality of modes, wherein in the first state, the codec operates in a first mode of plurality of modes, wherein in the second state, the codec operates in a second mode of plurality of modes, and wherein the second mode consumes less power than the first mode.

In another aspect, second power level is higher than the first power level, and the second state consumes more power than the first state. For example, the codec may operate at a higher average bit rate in the second state than in the first state.

In a separate aspect of the invention, there is also provided a wireless device having adaptable power consumption. The wireless device comprises a battery having a plurality of power levels; a codec having a plurality of states of operation; and a power management module configured to monitor a power level of the battery and provide a power level indication to the codec based on the power level. The wireless device operates at a first power level of the plurality of power levels and a first state of the plurality of states of operation, while in communication with a remote device, and wherein the power management module provides the power level indication to the codec indicative of a second power level of the plurality of power levels, and wherein the codec selects a second state of the plurality of states of operation corresponding to the second power level of the plurality of power levels and modifies the codec to operate at the second state of the plurality of states of operation.

Other features and advantages of the present invention will become more readily apparent to those of ordinary skill in the art after reviewing the following detailed description and accompanying drawings.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 illustrates a block diagram of a wireless telephone with adaptable power consumption, according to one embodiment of the present invention; and

FIG. 2 illustrates a flow diagram for adapting power consumption of the wireless telephone of FIG. 1, according to one embodiment of the present invention.

### DETAILED DESCRIPTION OF THE INVENTION

The present invention is directed to extending the battery life of wireless telephones by adapting power consumption. Although the invention is described with respect to specific embodiments, the principles of the invention, as defined by the claims appended herein, can obviously be applied beyond the specifically described embodiments of the invention described herein. For example, although the invention is described with reference to wireless telephones, the invention is not limited to such devices or systems and can be used in conjunction with any device or system that comprises an encoding scheme, e.g. voice codec, video codec, image codec, etc. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely example embodiments of the invention. To maintain brevity, other embodiments of the invention which use the principles of the present invention are not specifically described in the present application and are not specifically illustrated by the present drawings. It should be borne in mind that, unless noted otherwise, like or corresponding elements among the figures may be indicated by like or corresponding reference numerals.

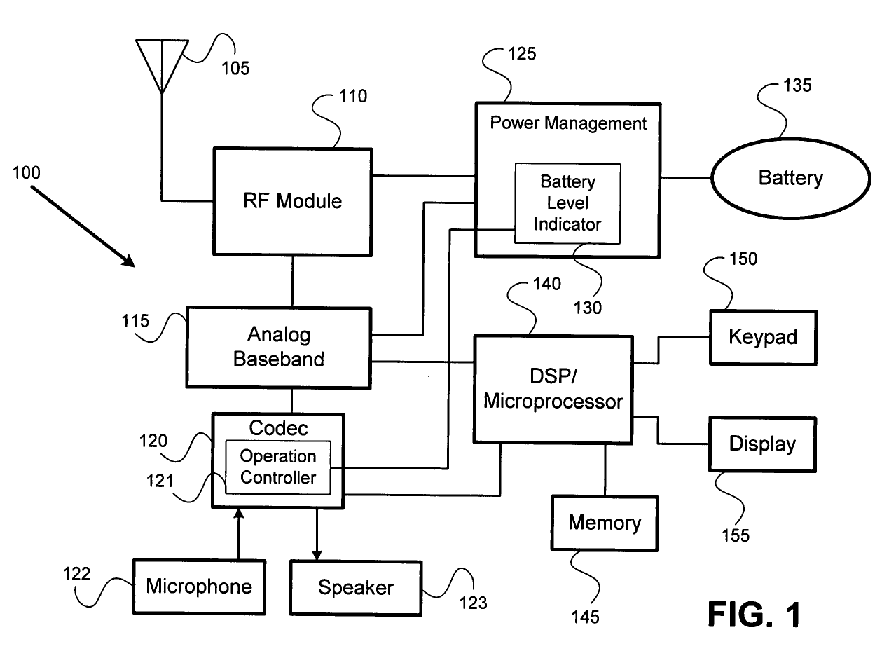

FIG. 1 illustrates a block diagram of wireless telephone 100 with adaptable power consumption, according to one embodiment of the present invention. As shown, wireless telephone 100 includes RF (Radio Frequency) module 110, where the radio frequency signal is filtered and downconverted to analog baseband signals in one direction, and in the other direction, analog baseband signals are filtered and then upconverted and amplified to generate radio frequency signals. In addition, wireless telephone 100 includes analog baseband module 115, where analog baseband signals received from RF module 110 are filtered, sampled and digitized before being fed to DSP/microprocessor 140. Further, analog baseband module 115 receives coded speech digital signal from codec 120, and samples and converts coded speech digital signal to analog baseband signals, which are provided to RF module 110 for transmission over antenna 105. Codec 120 can be a voice coder that receives a speech signal from microphone 122, and digitizes and codes the speech signal according to a voice coding scheme, such as Selectable Mode Vocoder (SMV), VMR-WB cdma2000, and the like. Codec 120 also receives a digitized and coded speech for decoding and transmission to speaker 123. Codec 120 can include a source-protection encoding and decoding module and a channel-protection encoding and decoding module (not shown), which are known to those of ordinary skill in the art. The digital signal processor (DSP) portion of DSP/microprocessor 140 is known in the art to perform signal manipulations and calculations at high speed. Whereas, the microprocessor portion of DSP/microprocessor 140 is known in the art to control the user interface, such as keypad 150 and display 155. The microprocessor is further used to coordinate the wireless phone functions and components. Memory 145 may include ROM, RAM, Flash memory, and the like, and provides storage space for the operation of wireless phone 100. Memory 145 may be used by DSP/microprocessor 140 for storing and retrieving information during the operation of wireless phone 100, as well as customizable features of wireless phone 100, such as a phone directory, ringer, etc. As shown, wireless phone 100 also includes battery 135 for providing power to wireless phone 100. Battery 135 can be recharged using a charger (not shown), which is known in the art. Power management 125 of wireless phone 100 regulates the power received from battery 135 for distribution in wireless phone 100.

Turning to codec 120 of wireless phone 100, as stated above, codec 120 may include coding schemes at various average bit rates and various complexities. For example, in one embodiment, codec 120 may operate according to the SMV speech coding scheme, which includes several modes of operation having different average data rates (ADRs), and which is described in 3^{rd} Generation Partnership Project 2 “3GPP2” Specification, entitled “Selectable Mode Vocoder Service Option for Wideband Spread Spectrum Communication Systems,” Version 2, dated December 2001, which is hereby incorporated by reference in its entirety. As described in the SMV specification, SMV includes three main modes of operation, where the first mode or mode 0 has a higher average bit rate than the second mode or mode 1 and is designed to achieve a higher quality than mode 1; and mode 1 has a higher average bit rate than the third mode or mode 2 and is designed to achieve a higher quality than mode 2. Other modes of operation have also been designed for SMV, such as special modes of modes 0 and 1, where the maximum allowable rate is the half rate, and these new modes are referred to as modes 4 and 5, respectively. SMV has full rate at 8.55 kbps, half rate at 4.0 kbps, quarter rate at 2.0 kbps and eighth rate at 0.8 kbps.

In one embodiment of the present invention, power management 125 includes battery level indicator 130, which indicates a power level based on remaining battery power. For example, the battery level can be indicated by numbers 0-15, where 0 indicates that the battery is completely depleted, and 15 indicates that the battery is completely full. As shown, battery level indicator 130 is in communication with operation controller 121 of codec 120. Operation controller 121 adapts the operation of codec 120 according to the battery level indicated by battery level indicator. For example, if battery level indicator 130 indicates that the battery level has decreased, operation controller 121 may select a state of operation for codec 120 that consumes less power in order to increase the life of battery 135. To reduce power, operation controller 121 may reduce average bit rate of codec 120. For example, if codec 120 is operating at mode 0, the average bit rate may be reduced if the codec is switched to mode 1.

It should be noted that the average transmit power, which is the power consumed by RF module 110, is directly proportional to the average bit rate. In other words, the lower the average bit rate, the lower the average transmit power, which results in less power consumption by RF module 110. For example, lowering the average bit rate lowers the average transmit power for given cell constellation and user location within the cell. Although a cell phone at the borderline of a given cell or in a heavily congested cell might requires a higher power than a cell phone closer to the center of a given cell or in a lightly utilized cell, it still remains that switching to a lower average bit rate will reduce the power needed to maintain the connection in a particular cell/user scenario.

In another embodiment, the average bit rate may be maintained, but complexity of the coding scheme may be reduced to conserve power. Yet, in other embodiments, operation controller 121 may use a table for corresponding the battery level indicator received from battery level indicator 130 to a state of operation of codec 120. For example, the state of operation can be based on both the average bit rate and complexity of the coding scheme. In an embodiment that operates according to the SMV speech coding scheme, operation controller 121 may switch from one SMV mode to another based on the battery level. In addition, if battery 135 is being charged, battery level indicator 130 may indicate an increase in power. In such event, operation controller 121 may select a mode of SMV that consumes more power and/or increases complexity of the coding scheme, which provides a superior voice quality.

It should be noted that similar scheme is applicable to other coding schemes that may be utilized by codec 120. As an example, the VMR-WB speech coding scheme, which also includes various modes of operation and average bit rates, is described in 3GPP2 Specification, entitled “Source-Controlled Variable-Rate Multimode Wideband Speech Codec (VMR-WB) Service Option 62 for Spread Spectrum Systems”, Version 1.0, dated July 2004, which is hereby incorporated by reference in its entirety. As described in the VMR-WB specification, it includes four main modes of operation, where the first mode or mode 0, is designed to achieve better quality than 3GPP/AMR-WB at 14.25 kbps; the second mode or mode 1, is designed to achieve better quality than 3GPP/AMR-WB at 12.65 kbps; the third mode or mode 2, is designed to achieve better quality than 3GPP/AMR-WB at 8.85 kbps; and the fourth mode or mode 3, is designed to achieve better quality than 3GPP/AMR-WB at 12.65 kbps. The VMR-WB speech coding scheme has full rate at 13.3 kbps, half rate at 6.2 kbps, quarter rate at 2.7 kbps and eighth rate at 1.0 kbps.

As stated above, if battery level indicator 130 indicates that the battery level has decreased, operation controller 121 may select a state of operation for codec 120 that consumes less power in order to increase the life of battery 135, such as reduction of average bit rate for the VMR-WB coder, reduce complexity of the coding scheme and/or switch from one VMR-WB mode to another, e.g. from mode 0 to mode 2.

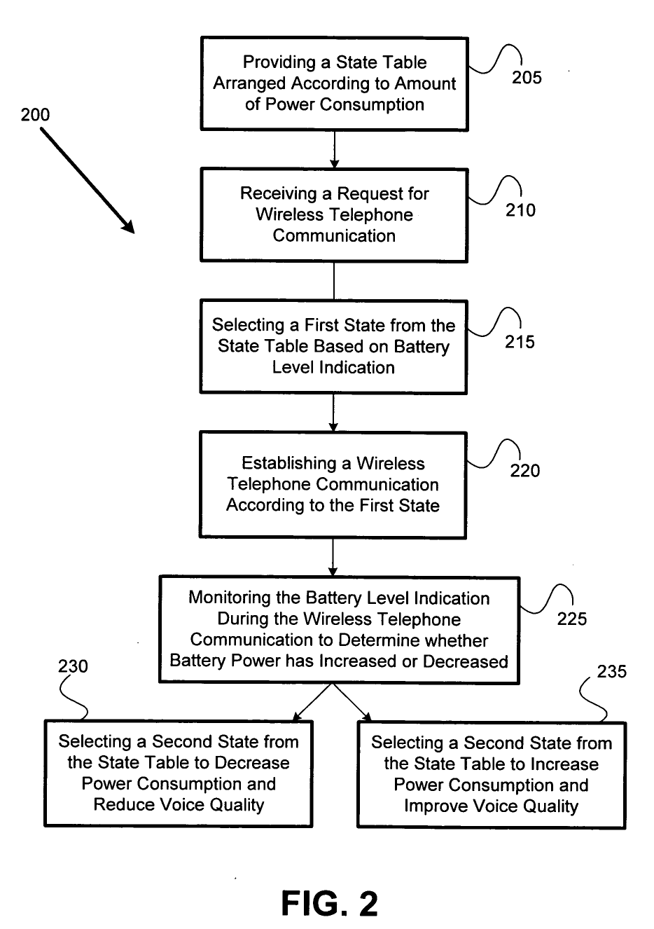

FIG. 2 illustrates flow diagram 200 for adapting power consumption of wireless telephone 100, according to one embodiment of the present invention. At step 205, according to one embodiment, there is provided a state table that includes various states of operation of codec 120 arranged according to the amount of power consumption by codec 120 in each state. In one embodiment, the state able can be arranges based on average bit rates, which can be directly proportional to power consumption. In another embodiment, the state table could be more complex and be arranged based on a combination of average bit rate and complexity of coding scheme. For example, it is possible for a complex 4.0 kbps coder to consume more power than a 8.5 kbps coder. Yet, in other embodiment, the table can be arranged according to one of multi-modes of operation of the codec, such as modes 0-3 of the VMR-WB coder.

Next, at step 210, wireless phone 100 receives a request to establish a wireless phone communication. At step 215, wireless phone 100 may select a first state of operation that is selected from the state table based on the battery level indication. For example, in one embodiment using SMV, if battery level indicator indicates that the battery level is low, e.g. 2 out of 15, operation controller 121 of codec 120 may limit codec 120 to a low average bit rate of mode 1 state of operation or a low complexity 4.0 kbps state of operation. Yet, in another embodiment using VMR-WB cdma2000, lower average bit rate mode 1 of VMR-WB may be selected by operation controller 121, as the state of operation.

At step 220, wireless telephone 100 establishes a wireless telephone communication according to the first state selected in step 210. Next, battery level indicator 130 provides updated indications to operation controller 121 at step 225, where battery 135 level is monitored to determine whether battery 135 power has decreased or increased. For example, if battery 135 power has increased due to battery 135 being charged while wireless telephone 100 is in operation, the process moves to step 235, where operation controller 221 may select a second state of operation to improve the voice quality, which increases power consumption, e.g. change VMR-WB mode 1 to mode 0, increase the average bit rate and/or increase complexity. Yet, if battery 135 power decreases due to battery 135 power being depleted, as wireless telephone 100 continues its operation, the process moves to step 230, where operation controller 221 may select a second state of operation to further decrease power consumption, e.g. change VMR-WB mode 1 to mode 2, reduce the average bit rate and/or reduce complexity, in order to increase communication time.

Although the present invention is described with reference to voice codecs; however, as stated above, the present invention can be utilized in conjunction with systems using video codecs, image codecs, and the like. For example, if a video clip is being encoded at a first average bit rate, the first average bit rate may be reduced to a second average bit rate if the battery level indicator indicates a lower battery level. Similarly, the average bit rate of an image codec may be reduced as the battery level decreases to save more power. In fact, for video and image transmission applications, the average bit rate can be initially set and adjusted based on a combination of the battery level and the size of the data that is being transmitted to provide a desired tradeoff between the quality and the quantity of the video and image transmitted given the battery level and the data size.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. For example, it is contemplated that the circuitry disclosed herein can be implemented in software, or vice versa. The described embodiments are to be considered in all respects as illustrative and not restrictive. It should also be understood that the invention is not limited to the particular embodiments described herein, but is capable of many rearrangements, modifications, and substitutions without departing from the scope of the invention.

1. A method of adjusting power consumption by a wireless device having a codec and a battery, said codec having a plurality of states of operation, said battery having a plurality of power levels, said method comprising:
operating said wireless device at a first power level of said plurality of power levels and a first state of said plurality of states of operation, while in communication with a remote device;
receiving a power level indication indicative of a second power level of said plurality of power levels;
selecting a second state of said plurality of states of operation for said codec corresponding to said second power level of said plurality of power levels; and
modifying said codec to operate at said second state of said plurality of states of operation.

2. The method of claim 1, wherein said second power level is lower than said first power level, and wherein said second state consumes less power than said first state.

3. The method of claim 2, wherein said codec operates at a lower average bit rate in said second state than in said first state.

4. The method of claim 2, wherein said codec has a plurality of modes, wherein in said first state, said codec operates in a first mode of plurality of modes, wherein in said second state, said codec operates in a second mode of plurality of modes, and wherein said second mode consumes less power than said first mode.

5. The method of claim 4, wherein said first mode is mode 0 of the VMR-WB and said second mode is mode 1 of said VMR-WB.

6. The method of claim 1, wherein said second power level is higher than said first power level, and wherein said second state consumes more power than said first state.

7. The method of claim 6, wherein said codec operates at a higher average bit rate in said second state than in said first state.

8. The method of claim 1, wherein said wireless device is a wireless telephone and said codec is a voice codec.

9. The method of claim 1, wherein said codec is a video codec.

10. The method of claim 9, wherein said selecting selects said second state of said plurality of states of operation for said codec corresponding to said second power level of said plurality of power levels and a size of video data.

11. The method of claim 1, wherein said codec is an image codec.

12. The method of claim 11, wherein said selecting selects said second state of said plurality of states of operation for said codec corresponding to said second power level of said plurality of power levels and a size of image data.

13. The method of claim 1 further comprising:
receiving said power level indication indicative of a third power level of said plurality of power levels;
selecting a third state of said plurality of states of operation for said codec corresponding to said third power level of said plurality of power levels; and
modifying said codec to operate at said third state of said plurality of states of operation.

14. A wireless device having adaptable power consumption, said wireless device comprising:
a battery having a plurality of power levels;
a codec having a plurality of states of operation; and
a power management module configured to monitor a power level of said battery and provide a power level indication to said codec based on said power level;
wherein said wireless device operates at a first power level of said plurality of power levels and a first state of said plurality of states of operation, while in communication with a remote device, and wherein said power management module provides said power level indication to said codec indicative of a second power level of said plurality of power levels, and wherein said codec selects a second state of said plurality of states of operation corresponding to said second power level of said plurality of power levels and modifies said codec to operate at said second state of said plurality of states of operation.

15. The wireless device of claim 14, wherein said second power level is lower than said first power level, and wherein said second state consumes less power than said first state.

16. The wireless device of claim 15, wherein said codec operates at a lower average bit rate in said second state than in said first state.

17. The wireless device of claim 15, wherein said codec has a plurality of modes, wherein in said first state, said codec operates in a first mode of plurality of modes, wherein in said second state, said codec operates in a second mode of plurality of modes, and wherein said second mode consumes less power than said first mode.

18. The wireless device of claim 17, wherein said first mode is mode 0 of the VMR-WB and said second mode is mode 1 of said VMR-WB.

19. The wireless device of claim 14, wherein said second power level is higher than said first power level, and wherein said second state consumes more power than said first state.

20. The wireless device of claim 19, wherein said codec operates at a higher average bit rate in said second state than in said first state.

21. The wireless device of claim 14, wherein said wireless device is a wireless telephone and said codec is a voice codec.

22. The wireless device of claim 14, wherein said codec is a video codec.

23. The wireless device of claim 22, wherein said codec selects said second state of said plurality of states of operation for said codec corresponding to said second power level of said plurality of power levels and a size of video data.

24. The wireless device of claim 14, wherein said codec is an image codec.

25. The wireless device of claim 24, wherein said codec selects said second state of said plurality of states of operation for said codec corresponding to said second power level of said plurality of power levels and a size of image data.

26. The wireless device of claim 14, wherein said power management module provides said power level indication to said codec indicative of a third power level of said plurality of power levels, and wherein said codec selects a third state of said plurality of states of operation corresponding to said third power level of said plurality of power levels and modifies said codec to operate at said third state of said plurality of states of operation.
